(19) United States
(12) Patent Application Publication
(10) Pub. No.: US 2022/0067624 A1
(43) Pub. Date: Mar. 3, 2022

(54) Incident Management Impact Assessment and Mapping

(71) Applicant: Bank of America Corporation, Charlotte, NC (US)

(72) Inventors: Elizabeth Swanzy-Parker, Charlotte, NC (US); Khalil Jackson, Charlotte, NC (US)

(21) Appl. No.: 17/010,559

(22) Filed: Sep. 2, 2020

(51) Int. Cl. G06Q 10/06; G06Q 10/10; G06Q 40/02; G06Q 40/08; G06Q 30/02; G06Q 30/00; G06F 13/20; H04L 29/06; G08B 5/22

(52) U.S. Cl. CPC G06Q 10/06375; G06Q 10/067; G06Q 10/10; G06Q 40/025; G08B 5/22; G06Q 30/0201; G06Q 30/0185; G06F 13/20; H04L 63/104; G06Q 40/08

(57) ABSTRACT

Aspects of the disclosure relate to incident management impact assessment and mapping. In some embodiments, a computing platform may receive a notification identifying an occurrence of a technology incident. Then, the computing platform may load a business capability model from a database. Based on the business capability model, the computing platform may identify one or more impacts of the technology incident. Based on identifying the one or more impacts of the technology incident, the computing platform may generate a first customized alert for a first user group of an organization. In addition, the first user group may be linked to at least one impact of the identified one or more impacts of the technology incident. In turn, the computing platform may send the first customized alert to at least one user device, causing the at least one user device to display the first customized alert.

### BACKGROUND

Aspects of the disclosure of the disclosure relate to preventing unauthorized access to computer systems and ensuring information security. In particular, one or more aspects of the disclosure relate to incident management impact assessment and mapping for secure information systems.

Technology issues or incidents can arise for any business and, generally, the faster the technology issues are resolved, the better. This is even more true where the technology at issue is critical to the business. For example, a financial institution experiencing a technology incident that affects financial transactions will generally want to track, identify, and resolve the incident as fast and efficiently as possible. In many instances, it may be difficult to determine the impact and urgency of each incident, and determine how to respond to each incident without undue delay. Accordingly, understanding data lineage (e.g., where the data came from, where the data is going) as well as any data transformation (e.g., how the data has changed along the way), from technical and business perspectives, are important aspects of incident management.

### SUMMARY

Aspects of the disclosure provide effective, efficient, scalable, and convenient technical solutions that address and overcome the technical problems associated with preventing unauthorized access to computer systems and ensuring information security. In particular, one or more aspects of the disclosure provide techniques for incident management impact assessment and mapping for secure information systems.

In accordance with one or more embodiments, a computing platform having at least one processor, a communication interface, and memory may receive, via the communication interface, a notification identifying an occurrence of a technology incident. Subsequently, the computing platform may load a business capability model from a database. Based on the business capability model, the computing platform may identify one or more impacts of the technology incident. Based on identifying the one or more impacts of the technology incident, the computing platform may generate a first customized alert for a first user group of an organization. In addition, the first user group may be linked to at least one impact of the identified one or more impacts of the technology incident. Then, the computing platform may send, via the communication interface, the first customized alert to at least one user device. In addition, sending the first customized alert may cause the at least one user device to display the first customized alert.

In some embodiments, based on identifying the one or more impacts of the technology incident, the computing platform may generate a second customized alert for a second user group of the organization, and send the second customized alert to at least one user device. In addition, the second user group may be linked to at least one impact of the identified one or more impacts. Furthermore, sending the second customized alert to the at least one user device may cause the at least one user device to display the second customized alert.

In some embodiments, based on identifying the one or more impacts of the technology incident, the computing platform may determine at least one automated response to the technology incident, generate commands directing at least one affected system to execute one or more mitigation actions, and send the commands to the at least one affected system. In addition, sending the commands to the at least one affected system may cause the at least one affected system to execute the commands.

In some embodiments, identifying the one or more impacts of the technology incident may include navigating a plurality of hierarchically maintained business capabilities in the business capability model. In addition, each business capability may be associated with one or more other business capabilities.

In some embodiments, identifying the one or more impacts of the technology incident may include assigning a priority level to the technology incident. In some embodiments, assigning the priority level to the technology incident may be based on a business impact caused by the technology incident.

In some embodiments, identifying the one or more impacts of the technology incident may include identifying impacts of the technology incident on one or more of: customers, processes, or business capabilities.

In some embodiments, identifying the one or more impacts of the technology incident may include navigating mapping data in the business capability model identifying relationships between technology systems in an enterprise computing environment and different customers, processes, or business capabilities.

In some embodiments, identifying the one or more impacts of the technology incident may include identifying a market risk, a compliance risk, a financial risk, a strategic risk, a credit risk, or a liquidity risk.

In some embodiments, sending the first customized alert may include sending to at least one computing device linked to a group within the organization or at least one computing device linked to a group outside of the organization.

In some embodiments, sending the first customized alert may cause the at least one user device to display a simulation of a cascading effect of the technology incident on a plurality of business capabilities.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for incident management impact assessment and mapping in accordance with one or more example embodiments;

FIGS. 2A-2C depict an illustrative event sequence for incident management impact assessment and mapping in accordance with one or more example embodiments; and

FIGS. 3-5 depict example graphical user interfaces for incident management impact assessment and mapping in accordance with one or more example embodiments; and

FIG. 6 depicts an illustrative method for incident management impact assessment and mapping in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

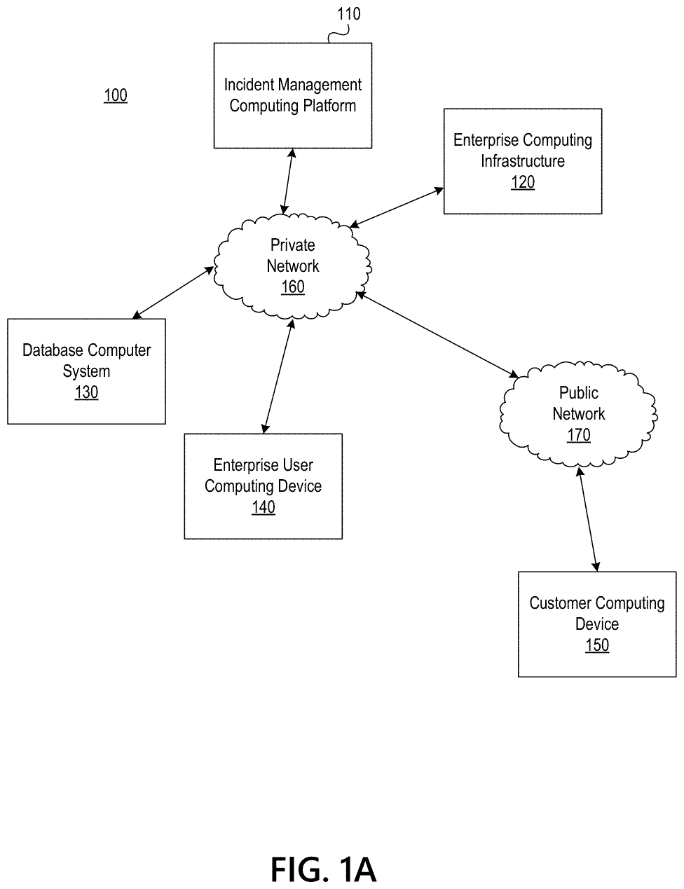

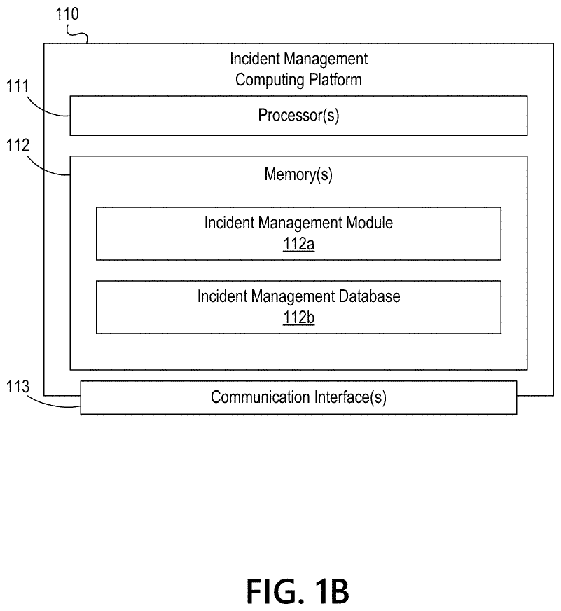

FIGS. 1A and 1B depict an illustrative computing environment for incident management impact assessment and mapping in accordance with one or more example embodiments. Referring to FIG. 1A, computing environment 100 may include one or more computing devices and/or other computing systems. For example, computing environment 100 may include incident management computing platform 110, enterprise computing infrastructure 120, database computer system 130, enterprise user computing device 140, and customer computing device 150. Although one enterprise user computing device 140 is shown for illustrative purposes, any number of enterprise user computing devices may be used without departing from the disclosure. Although one customer computing device 150 is shown for illustrative purposes, any number of customer computing devices may be used without departing from the disclosure.

As illustrated in greater detail below, incident management computing platform 110 may include one or more computing devices configured to perform one or more of the functions described herein. For example, incident management computing platform 110 may include one or more computers (e.g., laptop computers, desktop computers, servers, server blades, or the like).

Enterprise computing infrastructure 120 may include backend servers and systems. For example, the backend systems may include one or more computers or other computing devices such as one or more server systems, one or more processing devices such as a server, and one or more memory devices as well as one or more communication devices. The backend servers and systems may be mapped and/or linked to different business processes, as discussed in greater detail below.

Database computer system 130 may include different information storage entities storing one or more business capability models. For instance, a business capability model may include an integrated and comprehensive set of business capabilities that describe what an organization can do. The business capability model may be structured in a hierarchical manner, having several levels of depth and granularity. Database computer system 130 may also include a system of records (SOR). For example, database computer system 130 may include an application inventory tool (AIT) storing data about one or more applications that may be associated with a line or lines of business.

Enterprise user computing device 140 may include one or more computing devices and/or other computer components (e.g., processors, memories, communication interfaces). For instance, enterprise user computing device 140 may be a server, desktop computer, laptop computer, tablet, mobile device, or the like, and may be associated with an enterprise organization operating incident management computing platform 110. Customer computing device 150 may include one or more computing devices and/or other computer components (e.g., processors, memories, communication interfaces). For instance, customer computing device 150 may be a server, desktop computer, laptop computer, tablet, mobile device, or the like, and may be used by a customer of an organization, such as a customer of a financial institution.

Computing environment 100 also may include one or more networks, which may interconnect one or more of incident management computing platform 110, enterprise computing infrastructure 120, database computer system 130, enterprise user computing device 140, and customer computing device 150. For example, computing environment 100 may include private network 160 and public network 170. Private network 160 and/or public network 170 may include one or more sub-networks (e.g., local area networks (LANs), wide area networks (WANs), or the like).

Private network 160 may be associated with a particular organization (e.g., a corporation, financial institution, educational institution, governmental institution, or the like) and may interconnect one or more computing devices associated with the organization. For example, incident management computing platform 110, enterprise computing infrastructure 120, database computer system 130, and enterprise user computing device 140 may be associated with an organization (e.g., a financial institution), and private network 160 may be associated with and/or operated by the organization, and may include one or more networks (e.g., LANs, WANs, virtual private networks (VPNs), or the like) that interconnect incident management computing platform 110, enterprise computing infrastructure 120, database computer system 130, and enterprise user computing device 140 and one or more other computing devices and/or computer systems that are used by, operated by, and/or otherwise associated with the organization.

Public network 170 may connect private network 160 and/or one or more computing devices connected thereto (e.g., incident management computing platform 110, enterprise computing infrastructure 120, database computer system 130, and enterprise user computing device 140) with one or more networks and/or computing devices that are not associated with the organization. For example, customer computing device 150 might not be associated with an organization that operates private network 160, and public network 170 may include one or more networks (e.g., the Internet) that connect customer computing device 150 to private network 160 and/or one or more computing devices connected thereto (e.g., incident management computing platform 110, enterprise computing infrastructure 120, database computer system 130, and enterprise user computing device 140).

In one or more arrangements, incident management computing platform 110, enterprise computing infrastructure 120, database computer system 130, enterprise user computing device 140, and customer computing device 150 may be any type of computing device capable of receiving a user interface, receiving input via the user interface, and communicating the received input to one or more other computing devices. For example, incident management computing platform 110, enterprise computing infrastructure 120, database computer system 130, enterprise user computing device 140, customer computing device 150, and/or the other systems included in computing environment 100 may, in some instances, include one or more processors, memories, communication interfaces, storage devices, and/or other components. As noted above, and as illustrated in greater detail below, any and/or all of the computing devices included in computing environment 100 may, in some instances, be special-purpose computing devices configured to perform specific functions.

Referring to FIG. 1B, incident management computing platform 110 may include one or more processor(s) 111, memory(s) 112, and communication interface(s) 113. A data bus may interconnect processor 111, memory 112, and communication interface 113. Communication interface 113 may be a network interface configured to support communication between incident management computing platform 110 and one or more networks (e.g., private network 160, public network 170, or the like). Memory 112 may include one or more program modules having instructions that when executed by processor 111 cause incident management computing platform 110 to perform one or more functions described herein and/or one or more databases and/or other libraries that may store and/or otherwise maintain information which may be used by such program modules and/or processor 111.

In some instances, the one or more program modules and/or databases may be stored by and/or maintained in different memory units of incident management computing platform 110 and/or by different computing devices that may form and/or otherwise make up incident management computing platform 110. For example, memory 112 may have, store, and/or include an incident management module 112a and an incident management database 112b. Incident management module 112a may have instructions that direct and/or cause incident management computing platform 110 to, for instance, identify and assess impacts of a technology incident on customers, business processes, and/or business capabilities and determine how to respond to those impacts using, for example, information from a business capability model and/or instructions that direct and/or cause incident management computing platform 110 to perform other functions, as discussed in greater detail below. Incident management database 112b may store information used by incident management module 112a and/or incident management computing platform 110 in performing incident management impact assessment and mapping and/or in performing other functions, as discussed in greater detail below.

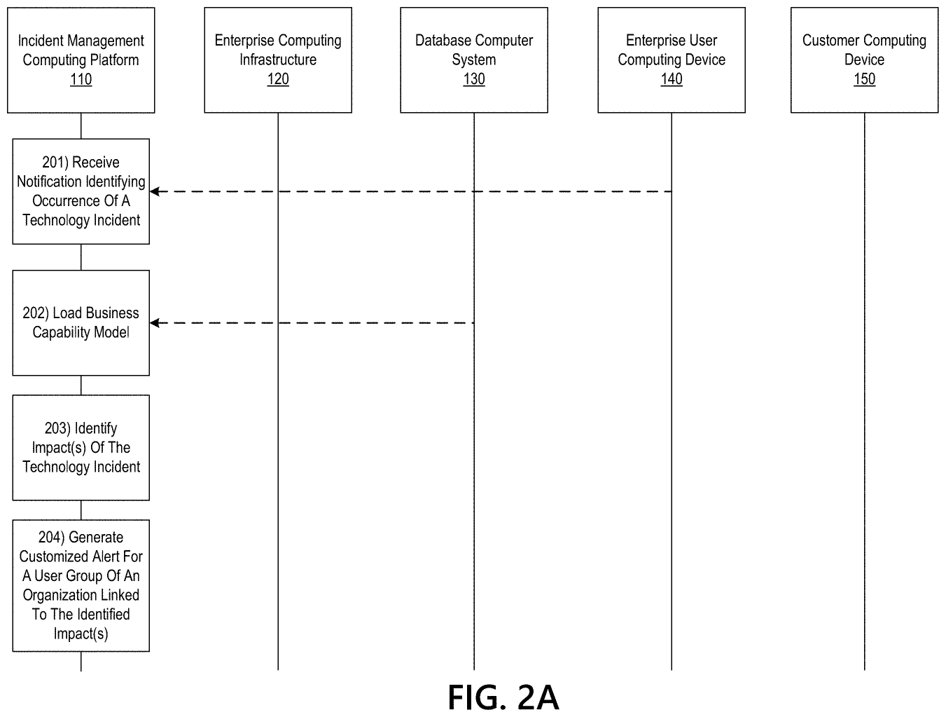

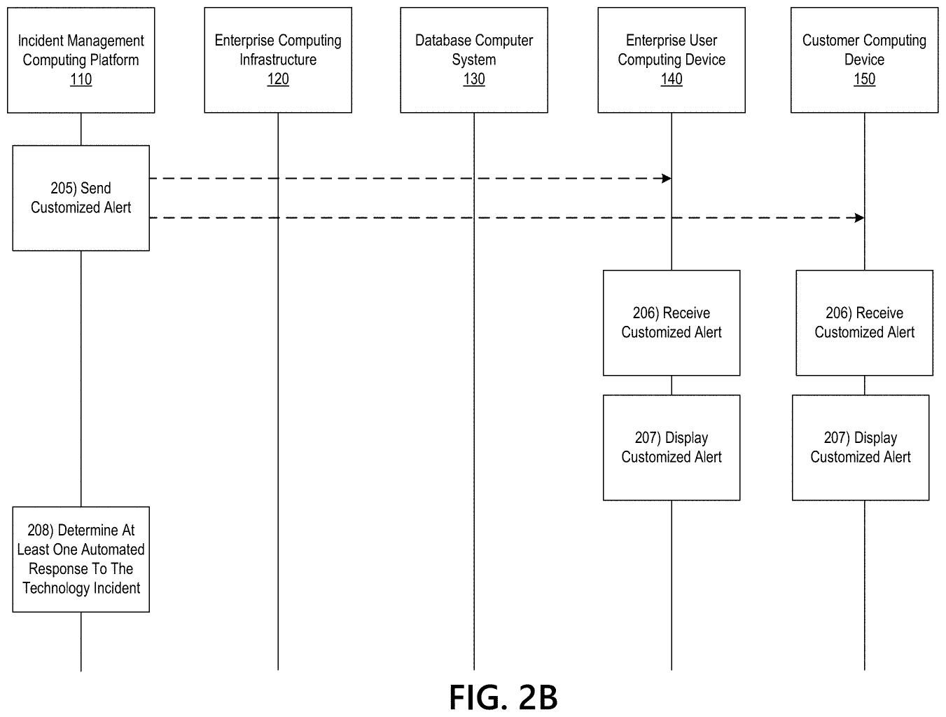

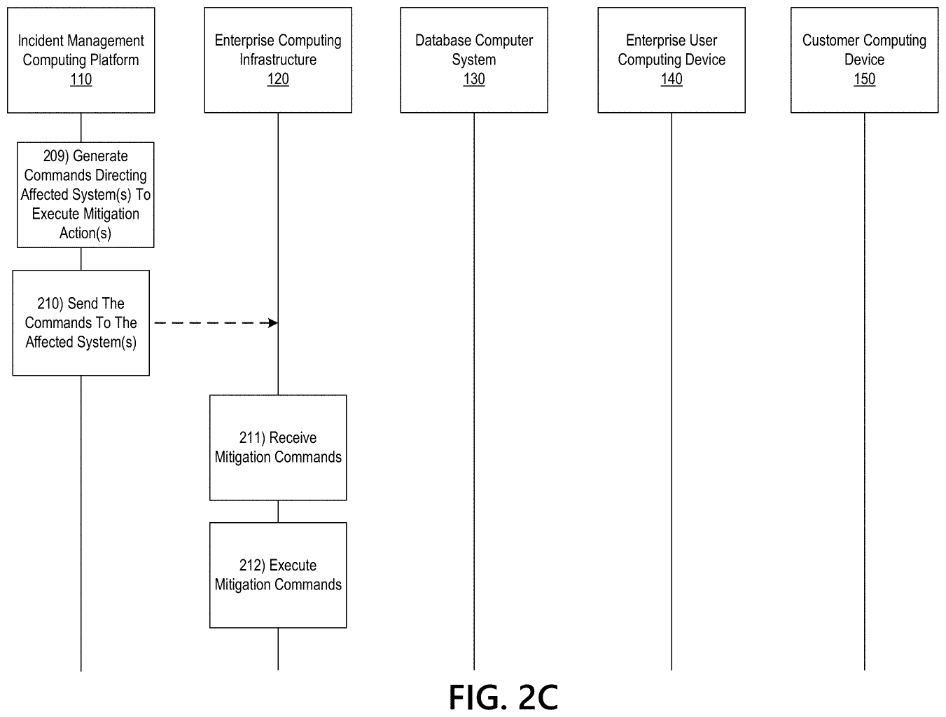

FIGS. 2A-2C depict an illustrative event sequence for incident management impact assessment and mapping in accordance with one or more example embodiments. Referring to FIG. 2A, at step 201, incident management computing platform 110 may receive, via a communication interface (e.g., communication interface 113), a notification identifying an occurrence of a technology incident. For example, incident management computing platform 110 may receive, from a computing device associated with an enterprise user (e.g., from enterprise user computing device 140), a notification indicating that an organization's systems or data may have been compromised, or a notification indicating a disruption of an operational process of an enterprise, business, or organization.

At step 202, incident management computing platform 110 may load a business capability model from a database (e.g., from database computer system 130). For example, the business capability model may provide graphical representations of organizational business capabilities (e.g., functions), their relationships, and hierarchy.

At step 203, incident management computing platform 110 may identify impacts of the technology incident (e.g., impacts to customers, business processes, or business capabilities) based on the retrieved business capability model. For example, incident management computing platform 110 may identify the impacts of the technology incident by navigating a plurality of hierarchically maintained business capabilities in the business capability model. For instance, incident management computing platform 110 may identify the impacts of the technology incident by navigating mapping data in the business capability model that identifies relationships between technology systems in an enterprise computing environment (e.g., in enterprise computing infrastructure 120) and different customers, processes, and/or business capabilities. In some embodiments, the technology incident may involve a market risk, a compliance risk, a financial risk, a strategic risk, a credit risk, and/or a liquidity risk. In some embodiments, in identifying the impacts of the technology incident, incident management computing platform 110 may assign a priority level to the technology incident by, for example, assessing a business impact caused by the technology incident.

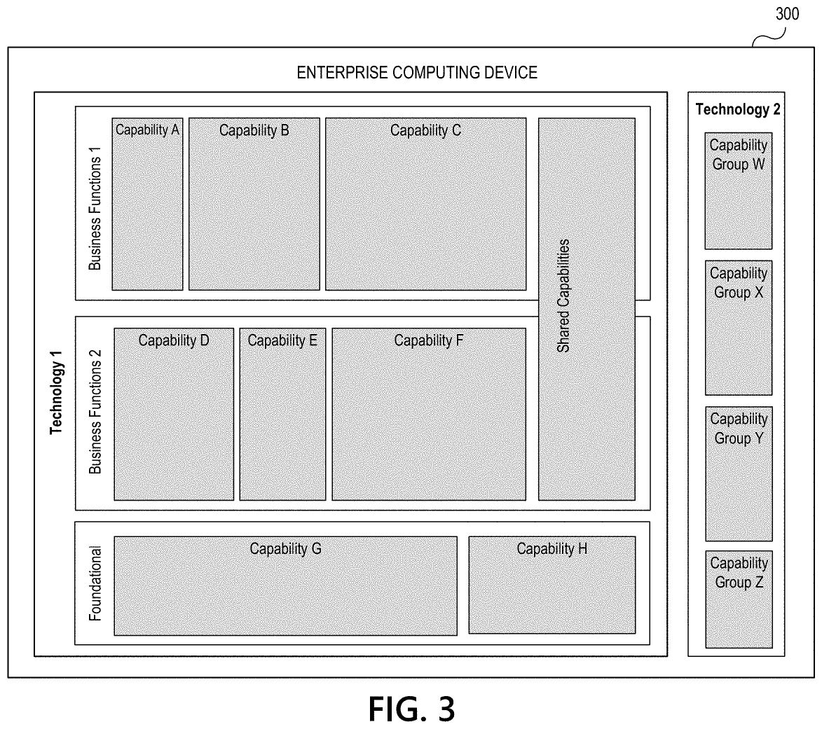

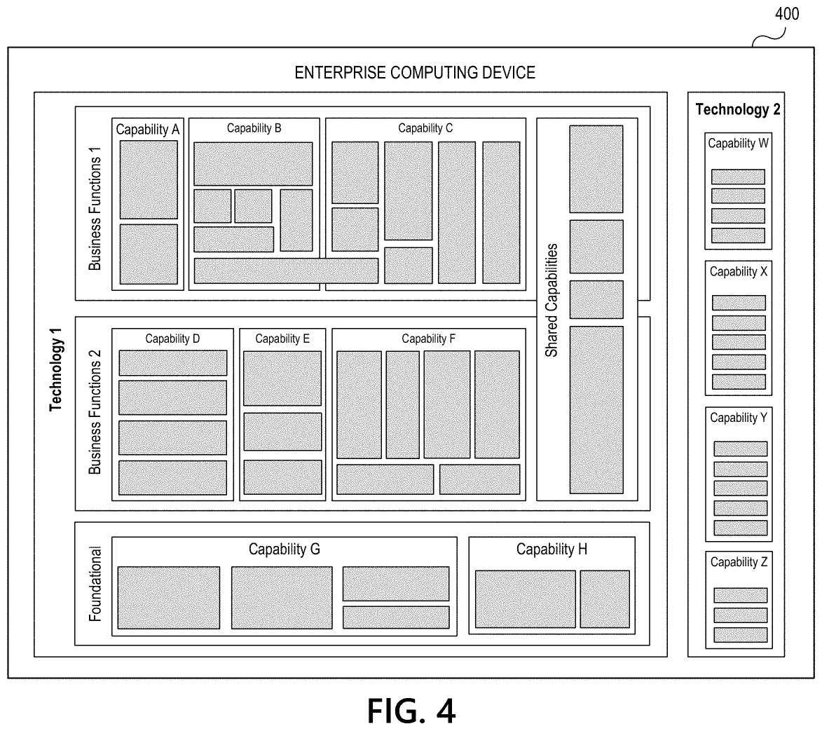

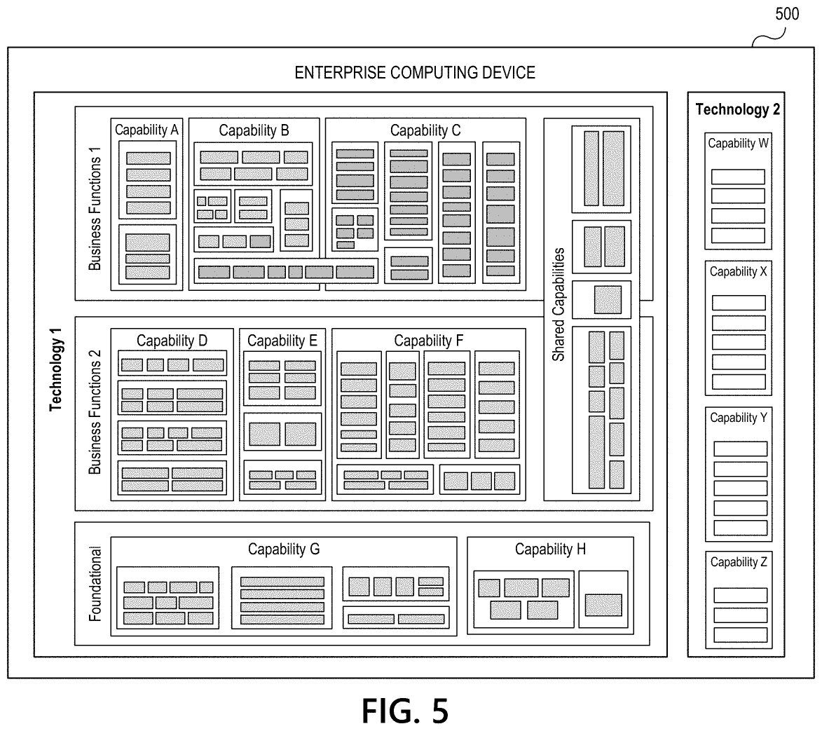

Referring to FIGS. 3-5, as shown in graphical user interfaces (GUIs) 300, 400, and 500, for example, the business capability model may be organized into multiple levels of capability data, each cell representing a business capability associated with underlying applications and/or systems, and each higher-level business capability including multiple constituting lower-level capabilities. As indicated by the cells highlighted in gray in each of GUIs 300, 400, and 500, the business capabilities may, for instance, be defined at different levels starting from an aggregate or top level (e.g., Level “0” as shown in GUI 300), to a first sub-level (e.g., Level “1” as shown in GUI 400), a second sub-level (e.g., Level “2” as shown in GUI 500), up to “N” levels (e.g., Level “N”), where N is greater than two. In some embodiments, each level may be linked to a preceding or following (e.g., adjacent) level or sequence of levels. For example, business areas within an organization may be classified as Level “0”, business function integrations within the business areas may be classified as Level “1”, and horizontal execution of the business functions may be classified as Level “2”.

In some embodiments, the levels may identify a level of risk, urgency, or impact of an event, situation, or condition to a business, clients, and/or the like. For example, an incident involving a Level “0” capability may have a higher impact on an organization (e.g., presenting a greater risk) than an incident involving a Level “1” capability, and therefore may be given higher priority or importance by incident management computing platform 110 during incident handling. Similarly, an incident involving a Level “1” capability may have a higher impact on an organization (e.g., presenting a greater risk) than an incident involving a Level “2” capability, and therefore may be given higher priority or importance during incident handling.

Returning to FIG. 2A, at step 204, based on identifying the one or more impacts of the technology incident, incident management computing platform 110 may generate a customized alert for a user group of an organization. The user group may be linked to at least one impact of the identified one or more impacts of the technology incident. For example, the customized alert may assist different groups in understanding the impact of a technology incident that occurred and its consequences to an organization's business objectives or to an organization's customers.

Referring to FIG. 2B, at step 205, incident management computing platform 110 may send, via the communication interface (e.g., communication interface 113), the customized alert to at least one user device. For example, in sending the customized alert, incident management computing platform 110 may send an alert to at least one computing device linked to a group within the organization (e.g., enterprise user computing device 140 linked to a software development group within an organization) and/or at least one computing device linked to a group outside of the organization (e.g., customer computing device 150 linked to a customer). At step 206, the at least one user device (e.g., enterprise user computing device 140 and/or customer computing device 150) may be caused to receive the customized alert from the incident management computing platform 110 and, at step 207, display the customized alert. In some embodiments, in sending the customized alert, incident management computing platform 110 may cause the at least one user device to display a simulation of a cascading effect of the technology incident on a plurality of business capabilities. For example, the at least one user device may be caused to display, in a visually representative manner, applications, systems and/or business functions that may be impacted by a technology incident, both upstream and downstream. In one example, the customized alert may track and graphically highlight linkages between impacted applications, systems, or the like. In another example, the customized alerts may visually identify or graphically highlight technology resources that have failed. In another example, the customized alert may visually display suggested mitigation actions and reconciliation actions based on prior history.

In a non-limiting example, incident management computing platform 110 may receive a notification identifying degradation of a capability to print checks and, based on a business capability model, incident management computing platform 110 may identify impacts of the degraded capability to different user groups within or outside of an organization. Subsequently, incident management computing platform 110 may generate and send a customized alert to at least one user device linked to a user group. For example, incident management computing platform 110 may alert a software development group of the need to write new code. Additionally or alternatively, incident management computing platform 110 may alert a business group to be prepared that customers may be disappointed or otherwise impacted by not being able to obtain checks. Additionally or alternatively, incident management computing platform 110 may alert customers that the capability to print checks has been impacted and that there may be delays associated with receiving their checks.

Additionally or alternatively, in some embodiments, based on identifying the one or more impacts of the technology incident (e.g., at step 203), incident management computing platform 110 may, at step 208, determine at least one automated response to the technology incident. Such an automated response may, for instance, include identifying a response process (e.g., tactically deploying resources within a computing infrastructure) and taking actions associated with a mitigation plan to efficiently trace, analyze, and/or manage risks associated with an enterprise, business, or organization.

Referring to FIG. 2C, at step 209, incident management computing platform 110 may generate commands directing at least one affected system to execute one or more mitigation actions. Such mitigation actions may include executing a set of actions to minimize negative impacts based upon a level of materiality or severity of a threat, or executing a set of actions to recover all or part of a loss. In one example, incident management computing platform 110 may generate commands directing at least one affected system to create a patch script to resolve or mitigate the need for new code. In another example, incident management computing platform 110 may generate commands directing at least one affected system to offer alternative ways for customers to receive services, such as offering electronic check processing to resolve or mitigate the effects of the degradation of the capability to print checks.

In turn, at step 210, incident management computing platform 110 may send the commands to the at least one affected system (e.g., backend servers and systems of enterprise computing infrastructure 120). At step 211, the at least one affected system may be caused to receive the mitigation commands from the incident management computing platform 110 and, at step 212, execute the mitigation commands.

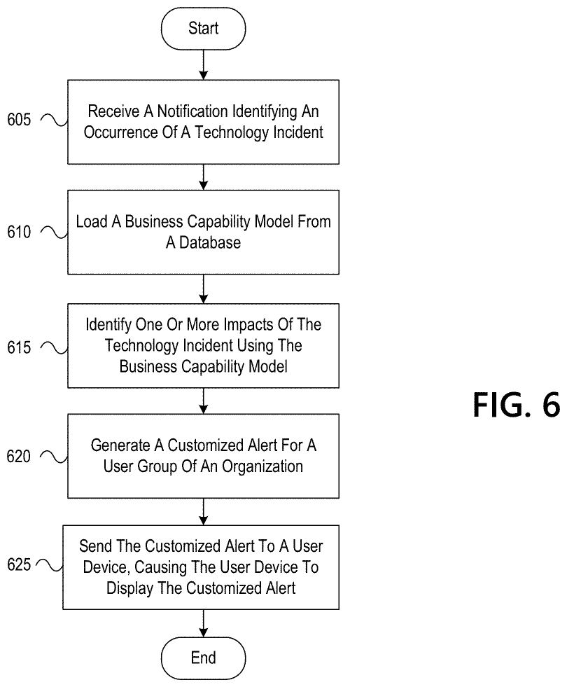

FIG. 6 depicts an illustrative method for incident management impact assessment and mapping in accordance with one or more example embodiments. Referring to FIG. 6, at step 605, a computing platform having at least one processor, a communication interface, and memory may receive, via the communication interface, a notification identifying an occurrence of a technology incident. At step 610, the computing platform may load a business capability model from a database. At step 615, based on the business capability model, the computing platform may identify one or more impacts of the technology incident. At step 620, based on identifying the one or more impacts of the technology incident, the computing platform may generate a first customized alert for a first user group of an organization. In addition, the first user group may be linked to at least one impact of the identified one or more impacts of the technology incident. At step 625, the computing platform may send, via the communication interface, the first customized alert to at least one user device. In addition, sending the first customized alert may cause the at least one user device to display the first customized alert.

Subsequently, the method may end. As illustrated in the examples above, however, certain aspects of the incident management impact assessment and mapping may be repeated (e.g., in identifying impacts of technology incidents using business capability models, and continuing to generate customized alerts in response to such incidents).

It should be understood that the steps described in the illustrative method may be performed in any order without departing from the scope of the disclosure. Furthermore, it should be understood that any of the steps described in the illustrative method above may be performed automatically, without being requested by a user input.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

1. A computing platform, comprising:
at least one processor;
a communication interface communicatively coupled to the at least one processor; and
memory storing computer-readable instructions that, when executed by the at least one processor, cause the computing platform to:
receive, via the communication interface, a notification identifying an occurrence of a technology incident, wherein the technology incident comprises an event, associated with one or more technology resources, that disrupts an operational process of an enterprise;
load a business capability model from a database;
based on the business capability model, identify one or more impacts of the technology incident;
based on identifying the one or more impacts of the technology incident, generate a first customized alert for a first user group of an organization, wherein the first user group is linked to at least one impact of the identified one or more impacts of the technology incident; and
send, via the communication interface, the first customized alert to at least one user device, wherein sending the first customized alert causes the at least one user device to display, on a display device of the at least one user device, a visual representation of upstream or downstream impacts of the technology incident on a plurality of business capabilities.

2. The computing platform of claim 1, wherein the memory stores additional computer-readable instructions that, when executed by the at least one processor, cause the computing platform to:
based on identifying the one or more impacts of the technology incident, generate a second customized alert for a second user group of the organization, wherein the second user group is linked to at least one impact of the identified one or more impacts; and
send, via the communication interface, the second customized alert to at least one user device, wherein sending the second customized alert to the at least one user device causes the at least one user device to display the second customized alert.

3. The computing platform of claim 1, wherein the memory stores additional computer-readable instructions that, when executed by the at least one processor, cause the computing platform to:
based on identifying the one or more impacts of the technology incident, determine at least one automated response to the technology incident;
generate commands directing at least one affected system to execute one or more mitigation actions; and
send the commands to the at least one affected system, wherein sending the commands to the at least one affected system causes the at least one affected system to execute the commands.

4. The computing platform of claim 1, wherein identifying the one or more impacts of the technology incident comprises navigating a plurality of hierarchically maintained business capabilities in the business capability model, wherein each business capability is associated with one or more other business capabilities.

5. The computing platform of claim 1, wherein identifying the one or more impacts of the technology incident comprises assigning a priority level to the technology incident.

6. The computing platform of claim 5, wherein assigning the priority level to the technology incident is based on a business impact caused by the technology incident.

7. The computing platform of claim 1, wherein identifying the one or more impacts of the technology incident comprises identifying impacts of the technology incident on one or more of: customers, processes, or business capabilities.

8. The computing platform of claim 1, wherein identifying the one or more impacts of the technology incident comprises navigating mapping data in the business capability model identifying relationships between technology systems in an enterprise computing environment and different customers, processes, or business capabilities.

9. The computing platform of claim 1, wherein identifying the one or more impacts of the technology incident comprises identifying a market risk, a compliance risk, a financial risk, a strategic risk, a credit risk, or a liquidity risk.

10. The computing platform of claim 1, wherein sending the first customized alert comprises sending the first customized alert to at least one computing device linked to a group within the organization or to at least one computing device linked to a group outside of the organization.

11. (canceled)

12. A method, comprising:
at a computing platform comprising at least one processor, a communication interface, and memory:
receiving, by the at least one processor, via the communication interface, a notification identifying an occurrence of a technology incident, wherein the technology incident comprises an event, associated with one or more technology resources, that disrupts an operational process of an enterprise;
loading, by the at least one processor, a business capability model from a database;
based on the business capability model, identifying, by the at least one processor, one or more impacts of the technology incident;
based on identifying the one or more impacts of the technology incident, generating, by the at least one processor, a first customized alert for a first user group of an organization, wherein the first user group is linked to at least one impact of the identified one or more impacts of the technology incident; and
sending, by the at least one processor, via the communication interface, the first customized alert to at least one user device, wherein sending the first customized alert causes the at least one user device to display, on a display device of the at least one user device, a visual representation of upstream or downstream impacts of the technology incident on a plurality of business capabilities.

13. The method of claim 12, further comprising:
based on identifying the one or more impacts of the technology incident, generating, by the at least one processor, a second customized alert for a second user group of the organization, wherein the second user group is linked to at least one impact of the identified one or more impacts; and
sending, by the at least one processor, via the communication interface, the second customized alert to at least one user device, wherein sending the second customized alert to the at least one user device causes the at least one user device to display the second customized alert.

14. The method of claim 12, further comprising:
based on identifying the one or more impacts of the technology incident, determining, by the at least one processor, at least one automated response to the technology incident;
generating, by the at least one processor, commands directing at least one affected system to execute one or more mitigation actions; and
sending, by the at least one processor, via the communication interface, the commands to the at least one affected system, wherein sending the commands to the at least one affected system causes the at least one affected system to execute the commands.

15. The method of claim 12, wherein identifying the one or more impacts of the technology incident comprises navigating a plurality of hierarchically maintained business capabilities in the business capability model, wherein each business capability is associated with one or more other business capabilities.

16. The method of claim 12, wherein identifying the one or more impacts of the technology incident comprises assigning a priority level to the technology incident.

17. The method of claim 16, wherein assigning the priority level to the technology incident is based on a business impact caused by the technology incident.

18. The method of claim 12, wherein identifying the one or more impacts of the technology incident comprises navigating mapping data in the business capability model identifying relationships between technology systems in an enterprise computing environment and different customers, processes, or business capabilities.

19. (canceled)

20. One or more non-transitory computer-readable media storing instructions that, when executed by a computing platform comprising at least one processor, a communication interface, and memory, cause the computing platform to:
receive, via the communication interface, a notification identifying an occurrence of a technology incident, wherein the technology incident comprises an event, associated with one or more technology resources, that disrupts an operational process of an enterprise;
load a business capability model from a database;
based on the business capability model, identify one or more impacts of the technology incident;
based on identifying the one or more impacts of the technology incident, generate a first customized alert for a first user group of an organization, wherein the first user group is linked to at least one impact of the identified one or more impacts of the technology incident; and
send, via the communication interface, the first customized alert to at least one user device, wherein sending the first customized alert causes the at least one user device to display, on a display device of the at least one user device, a visual representation of upstream or downstream impacts of the technology incident on a plurality of business capabilities.
